(19) United States
(12) Patent Application Publication
(10) Pub. No.: US 2005/0249954 A1
(43) Pub. Date: Nov. 10, 2005

(54) Method of Forming Multilayer Coating Films and Multilayer Coating Films

(75) Inventors: Daisuke Kawaguchi, Neyagawa-shi (JP); Masami Yabuta, Neyagawa-shi (JP)

Correspondence Address: CONNOLLY BOVE LODGE & HUTZ LLP, SUITE 800, 1990 M STREET NW, WASHINGTON, DC, 20036-3425, US

(73) Assignee: NIPPON PAINT CO., LTD., Osaka-shi (JP)

(21) Appl. No.: 10/908,355

(22) Filed: May 9, 2005

(30) Foreign Application Priority Data
May 10, 2004 (JP) 2004-140393

(51) Int. Cl. B32B 27/38; B05D 1/04; B05D 1/36; B05D 1/38

(52) U.S. Cl. 428/414; 428/413; 427/458; 427/410

(57) ABSTRACT

It is an object of the present invention to provide a method of forming multilayer coating films comprising a clear coating film which will not undergo unfavorable changes in appearance, such as yellowing, popping and/or pinhole formation while reducing the load on the environment as well as a multilayer coating film obtained by such method. A method of forming multilayer coating films on substrates having a cationically electrodeposited coating film using a water-borne intermediate coating composition, a water-borne base coating composition and a powder clear coating composition, wherein said method comprises: a step (I) of applying the water-borne intermediate coating composition, a step (B) of applying the water-borne base coating composition onto the intermediate coating film formed in the step (I), a step (P) of applying a primer onto the base coating film formed in the step (B) and a step (C) of applying the powder clear coating composition onto the primer coating film formed in the step (P), and a step (H) of curing by heating is carried out just after the step (B) and/or just after the step (P).

### TECHNICAL FIELD

The present invention relates to a method of forming multilayer coating films and to a multilayer coating film.

### BACKGROUND ART

Automotive bodies and parts generally have multilayer coating film obtained by electrodeposition, intermediate coating, base coating and clear coating and, in recent years, the reduction in amount of solvents in the coating compositions used in such coating steps has been demanded from the VOC reduction viewpoint, hence investigations have been made on the clear coating using a powder coating composition.

However, the two-coat one-bake technique comprising the step of baking an uncured base coating film and an uncured clear coating film simultaneously has a problem in that the moisture, solvent and so forth contained in the base coating film evaporate, causing the clear coating film to suffer popping, pinhole formation, yellowing, etc. In particular, when a powder clear coating composition is used, it is difficult for such volatile compounds as mentioned above to pass through the coating film since the melt viscosity is high from the beginning of the melting by heating; thus, those problems arise more remarkably as compared with the case of using a conventional solvent-borne clear coating composition.

Japanese Kokai Publication 2002-126625 discloses a method of applying water-borne coating compositions, in particular a method of forming coating films excellent in appearance without allowing yellowing in a three wet coating system which method comprises forming coating films in a manner such that the total amount of the volatile basic substances per unit area (1 mm²) of the coating film formed by application of a water-borne coating composition may amount to not more than 7×10⁶ mmol. However, investigations have been made there only from the coating composition viewpoint and no approach has been made from the coating process viewpoint.

Japanese Kokai Publication 2002-86061 discloses that when, for providing over clear coats on automotive bodies, a transparent primer containing an alkoxysilyl group- and epoxy group-containing resin (I) in a specific proportion is applied onto a topcoat and, further, an over clear coating composition is applied thereonto, coating films excellent in adhesion can be obtained. However, there is no suggestion at all about the water-borne three wet coating system, and no approach has been made to the problem of yellowing from the coating process viewpoint.

As a method of solving these problems, a method comprising curing, by heating, the base coating film to thereby remove volatile compounds and then applying a powder clear coating composition may be considered. However, when such a method is carried out, a problem arises; since the adhesion between the cured base coating film and the powder clear coating composition is low, it is difficult to obtain a clear coating film satisfactory in adhesion and film strength.

### SUMMARY OF THE INVENTION

In view of the foregoing, it is an object of the present invention to provide a method of forming multilayer coating films comprising a clear coating film which will not undergo unfavorable changes in appearance, such as yellowing, popping and/or pinhole formation while reducing the load on the environment as well as a multilayer coating film obtained by such method.

The present invention relates to a method of forming multilayer coating films on substrates having a cationically electrodeposited coating film using a water-borne intermediate coating composition, a water-borne base coating composition and a powder clear coating composition,
wherein the method comprises:
a step (I) of applying the water-borne intermediate coating composition,
a step (B) of applying the water-borne base coating composition onto the intermediate coating film formed in the step (I),
a step (P) of applying a primer onto the base coating film formed in the step (B) and
a step (C) of applying the powder clear coating composition onto the primer coating film formed in the step (P), and
a step (H) of curing by heating is carried out just after the step (B) and/or just after the step (P).

The primer is preferably a solvent-borne one and comprises an alkoxysilyl group- and epoxy group-containing resin (A).

The primer is preferably a water-borne one.

The powder clear coating composition is preferably a suspension-derived powder coating composition.

The substrates are preferably automotive bodies or automotive parts.

The invention also relates to a multilayer coating film, which is obtained by the above-mentioned method of forming multilayer coating films.

### BRIEF DESCRIPTION OF THE DRAWINGS

FIG. 1 is a schematic view of a multilayer coating film obtained by the method of forming multilayer coating films according to the invention.

FIG. 2 is a schematic view of a multilayer coating film obtained by the method of forming multilayer coating films according to the invention.

FIG. 3 is a schematic view of a multilayer coating film obtained by the method of forming multilayer coating films according to the invention.

FIG. 4 is a schematic view of a multilayer coating film obtained by the method of forming multilayer coating films according to the invention.

FIG. 5 is a schematic view of a multilayer coating film obtained by the method of forming multilayer coating films according to the invention.

FIG. 6 is a schematic view of a multilayer coating film obtained by the method of forming multilayer coating films according to the invention.

### EXPLANATION OF THE NUMERICAL SYMBOLS

1 an electrodeposited coating film
2 an intermediate coating film
3 a base coating film
4 a primer coating film
5 a clear coating film

### DETAILED DESCRIPTION OF THE INVENTION

In the following, the invention is described in detail.

The method of forming multilayer coating films according to the invention is a method of forming multilayer coating films on a substrate having a cationically electrodeposited coating film using a water-borne intermediate coating composition, a water-borne base coating composition and a powder clear coating composition. Thus, it is a method of forming multilayer coating films without using any solvent-borne coating composition and, therefore, it exercises only slight influence on the environment. Since it is an important object of the invention to reduce the influence on the environment, the intermediate coating composition and base coating composition to be used are also of the water-borne type.

In using a water-borne coating composition, a resin is dispersed in water and, therefore, an amine compound or the like is used to neutralize the carboxylic acid group or the like in the resin. The amine compound or the like evaporates in the step of curing by heating and, as a result, the clear coating film tends to undergo unfavorable changes in appearance, such as yellowing, popping and/or pinhole formation. The method of the present invention also serves as a method of preventing such unfavorable changes in appearance from occurring.

To prevent such unfavorable changes in appearance as mentioned above, the method of the present invention forms coating films by curing, by heating, the water-borne base coating composition and water-borne intermediate coating composition prior to application of the powder clear coating composition. Thus, the above-mentioned amine compound or the like is caused to evaporate in the step of curing by heating prior to application of the powder clear coating composition and, thereafter, the powder clear coating composition is applied, whereby the powder clear coating film can be prevented from undergoing unfavorable changes in appearance. Further, whereas, in the art, no satisfactory level of adhesion can be retained because the adhesion between the base coating film cured by heating and the powder clear coating film is not good, the application of a primer onto the base coating film in accordance with the invention makes it possible to increase the adhesion of the powder clear coating composition to give a good clear coating film.

In accordance with the present invention, the step (H) of curing by heating is carried out just after the step (B) of applying the water-borne base coating composition and/or the step (P) of applying the primer onto the base coating film. Thus, in accordance with the invention, the base coating film is cured by heating by any of the following methods: (i) curing by heating after successive application of the base coating composition and the primer, (ii) curing by heating after application of the base coating composition but prior to primer application and (iii) curing by heating after application of the base coating composition and further curing by heating after application of the primer.

When the step (H) of curing by heating is carried out just after application of at least one of the base coating composition and primer, as mentioned above, the solvent, amine compound and so forth can be evaporated effectively and a clear coating film can be formed without occurrence of unfavorable changes in appearance, such as yellowing, popping, pinhole formation, etc. While the step (H) of curing by heating may be carried out twice, namely just after the step (B) and just after the step (P), it is preferred, from the process shortening viewpoint, that the step (H) be carried out only once, namely just after the step (B) or (P).

In carrying out the method of forming multilayer coating films according to the invention, the application of the water-borne intermediate coating composition may be followed either by curing by heating or by wet-on-wet application of the water-borne base coating composition while the intermediate coating film remains uncured. The term “uncured” as used herein conceptually includes, for example, the state after preheating as well. The preheating is the step, after application, of allowing to stand or heating at room temperature to a temperature lower than 100° C. for 1 to 10 minutes to thereby evaporate the moisture and/or solvent.

The heating conditions in the step (H) of curing by heating are not particularly restricted but, preferably, the heating is carried out at 130 to 180° C. for about 25 minutes. The base coating film and/or primer coating film before carrying out the step (H) of curing by heating is preferably preheated under the conditions mentioned above.

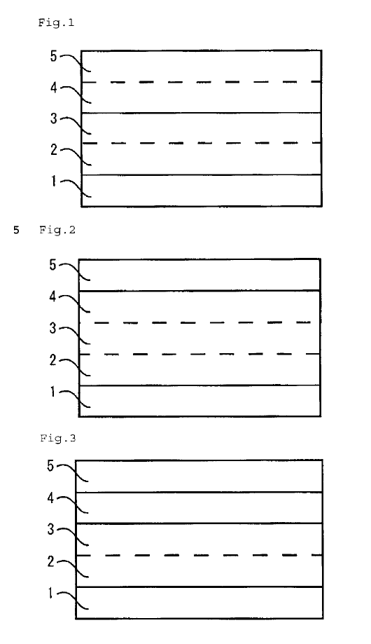

Typical modes of embodiment of the present invention such as mentioned above may be illustrated as shown in FIGS. 1 to 6. The solid lines in FIGS. 1 to 6 each represents an interface resulting from application followed by curing by heating and the subsequent next coating film formation, and each dotted line represents an interface resulting from application and the subsequent coating film formation while the prior coating film or coating films remain uncured.

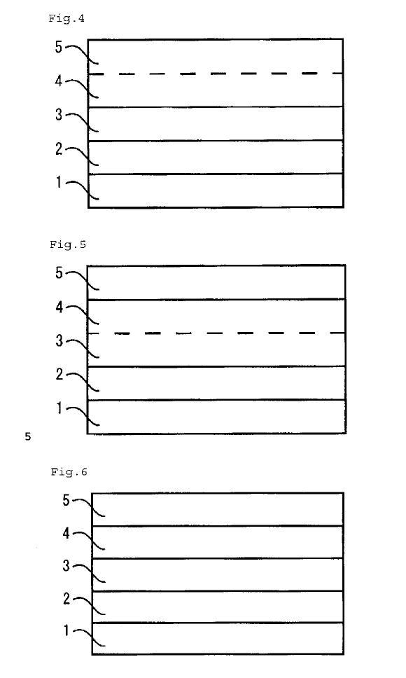

According to FIG. 1, the step of curing by heating is carried out just after application of the water-borne base coating composition. According to FIG. 2, the step of curing by heating is carried out just after application of the primer. According to FIG. 3, the step of curing by heating is carried out just after application of the water-borne base coating composition and primer. According to FIG. 4, the step of curing by heating is carried out just after application of the water-borne intermediate coating composition and just after application of the water-borne base coating composition. According to FIG. 5, the step of curing by heating is carried out just after application of the water-borne intermediate coating composition and just after application of the primer. According to FIG. 6, the step of curing by heating is carried out just after application of the water-borne intermediate coating composition and just after application of the water-borne base coating composition and the primer.

These methods all give good multilayer coating film without showing such unfavorable changes in appearance as yellowing, popping, pinhole formation, etc.

The primer to be used in the practice of the invention is not particularly restricted but may be a water-borne one or a solvent-borne one. Preferred is one containing an alkoxysilyl group- and epoxy group-containing resin (A). By applying a primer containing the resin (A), it becomes possible to improve the adherence of the powder clear coating composition and to obtain a good clear coating film.

The alkoxysilyl group- and epoxy group-containing resin (A) can be obtained by copolymerization using an alkoxysilyl group-containing, radical-polymerizable monomer (A-1) and an epoxy group-containing, radical-polymerizable monomer (A-2) as monomer components. It is also possible to use, as the alkoxysilyl group- and epoxy group-containing resin (A), a mixture of an alkoxysilyl group-containing, epoxy group-free resin and an alkoxysilyl group-free, epoxy group-containing resin or a mixture comprising these resins and, further, an alkoxysilyl group- and epoxy group-containing resin.

What is meant is that the alkoxysilyl group- and epoxy group-containing resin (A), only as a whole, is required to contain alkoxysilyl groups and epoxy groups. The alkoxysilyl group- and epoxy group-containing resin (A) is preferably an acrylic copolymer and, therefore, a group represented by the general formula (1): 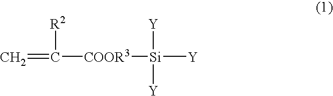
wherein R² represents a hydrogen atom or a methyl group, R³ represents a hydrocarbon group containing 1 to 6 carbon atoms, the three Y groups may be the same or different and each represents a hydrogen atom, a hydroxyl group, an alkoxyl group containing 1 to 4 carbon atoms or a C1-8 alkyl, aryl or aralkyl group, provided that at least one of the Y groups is an alkoxyl group containing 1 to 4 carbon atoms, is preferably used as the alkoxysilyl group-containing, radical-polymerizable monomer (A-1). As the hydrocarbon group containing 1 to 6 carbon atoms represented by R3, there may be mentioned straight or branched divalent alkyl groups, alkenyl groups, aryl groups and so forth. The alkoxyl, alkyl or aralkyl group represented by Y may be straight or branched.

As specific examples of the alkoxysilyl group-containing, radical-polymerizable monomer (A-1) represented by the general formula (1), there may be mentioned, among others, γ-(meth)acryloxypropyltrimethoxysilane, γ-(meth)acryloxypropyltriethoxysilane, γ-(meth)acryloxypropyltripropoxysilane, γ-(meth)acryloxypropylmethyldimethoxysilane, γ-(meth)acryloxypropylmethyldiethoxysilane, γ-(meth)acryloxypropylmethyldipropoxysilane, γ-(meth)acryloxybutylphenyldimethoxysilane, γ-(meth)acryloxybutylphenyldiethoxysilane, γ-(meth)acryloxybutylphenyldipropoxysilane, γ-(meth)acryloxypropyldimethylmethoxysilane, γ-(meth)acryloxypropyldimethylethoxysilane, γ-(meth)acryloxypropylphenylmethylmethoxysilane, and γ-(meth)acryloxypropylphenylmethylethoxysilane. These may be used singly or two or more of them may be used in combination.

The epoxy group-containing, radical-polymerizable monomer (A-2) is not particularly restricted but includes, among others, glycidyl(meth)acrylate, 3,4-epoxycyclohexanylmethyl methacrylate, and like epoxy group-containing acrylic monomers. These may be used singly or two or more of them may be used in combination.

The monomer component other than the alkoxysilyl group-containing, radical-polymerizable monomer (A-1) and epoxy group-containing, radical-polymerizable monomer (A-2) is not particularly restricted but a hydroxyl group-containing, radical-polymerizable monomer (A-3) is preferably used. The hydroxyl group-containing, radical-polymerizable monomer (A-3) is not particularly restricted but includes, among others, hydroxyalkyl(meth)acrylates such as 2-hydroxyethyl(meth)acrylate, 2-hydroxypropyl(meth)acrylate and 4-hydroxybutyl(meth)acrylate; Placcel FM-1 (trademark; 2-hydroxyethyl(meth)acrylate-polycaprolactone adduct, product of Daicel Chemical Industry Co.); polyalkylene glycol mono(meth)acrylates and the like. These may be used singly or two or more of them may be used in combination.

Further, the other monomer (A-4) is not particularly restricted but includes, among others, aromatic vinyl monomers such as styrene, α-methylstyrene, other styrenics and vinyltoluene; acrylate esters such as methyl acrylate, ethyl acrylate, propyl acrylate, n-, iso- or tert-butyl acrylate, 2-ethylhexyl acrylate and lauryl acrylate; methacrylate esters such as methyl methacrylate, ethyl methacrylate, propyl methacrylate, n-, iso- or tert-butyl methacrylate, 2-ethylhexyl methacrylate and lauryl methacrylate; acrylamide monomers such as acrylamide, methacrylamide, N-ethyl(meth)acrylamide, N,N-butoxymethyl(meth)acrylamide and N-methylacrylamide; amino group-containing monomers such as dimethylaminoethyl(meth)acrylate and diethylaminoethyl(meth)acrylate; acrylonitrile, vinyl acetate, acrylic acid, methacrylic acid, etc. These may be used singly or two or more of them may be used in combination.

The alkoxysilyl group-containing, radical-polymerizable monomer (A-1) is preferably contained in the monomer composition in an amount within the range of a lower limit of 5% by weight to an upper limit of 50% by weight. When the addition level is lower than 5% by weight, the primer coating film obtained will be poor in adhesion and water resistance. At levels exceeding 50% by weight, the hydrophilicity will become excessive and poor storage stability will result.

The epoxy group-containing, radical-polymerizable monomer (A-2) is preferably contained in the monomer component in an amount within the range from a lower limit of 10% by weight to an upper limit of 50% by weight. At addition levels lower than 10% by weight, the primer coating film obtained will be poor in adhesion. At levels exceeding 50% by weight, the storage stability will be poor. Among the other monomers, the hydroxyl group-containing, radical-polymerisable monomer (A-3) is preferably contained in the monomer composition in an amount within the range from a lower limit of 5% by weight to an upper limit of 40% by weight. At levels lower than 5% by weight, the curability will be poor and, at levels exceeding 40% by weight, the water resistance will be poor in certain instances.

The alkoxysilyl group- and epoxy group-containing resin (A) can be obtained by copolymerizing the above-mentioned monomer components in the presence of a radical polymerization initiator. In cases where at least two resin species separately and respectively containing alkoxysilyl groups and epoxy groups are used, a resin obtained by copolymerization of the above-mentioned alkoxysilyl group-containing, radical-polymerizable monomer (A-1), together with the hydroxyl group-containing, radical-polymerizable monomer (A-3) and the other monomer (A-4), if desired, and a resin obtained by copolymerization of the above-mentioned epoxy group-containing, radical-polymerizable monomer (A-2), together with the hydroxyl group-containing, radical-polymerizable monomer (A-3) and the other monomer (A-4), if desired, can be used in admixture. The method of copolymerization is not particularly restricted but the polymerization can be carried out in the manner of ordinary solution polymerization etc., such as radical polymerization, for example at a polymerization temperature of 100 to 140° C. for a polymerization time of 3 to 8 hours.

The radical polymerization initiator is not particularly restricted but includes, among others, tert-butyl peroxy-2-ethylhexanoate, dimethyl 2,2′-azobisisobuytrate and the like. These may be used singly or two or more of them may be used in combination. The radical polymerization initiator is preferably used in an amount within the range of a lower limit of 3% by weight to an upper limit of 15% by weight relative to the whole amount of the monomers mentioned above. In carrying out the copolymerization, a chain transfer agent, for instance, may also be used as an additive.

The alkoxysilyl group- and epoxy group-containing resin (A) preferably has a number average molecular weight (Mn) within the range of a lower limit of 1 000 to an upper limit of 8000. At levels lower than 1 000, the primer coating film obtained will exhibit poor performance characteristics and weathering resistance and, at levels exceeding 8000, poor workability will result. The resin (A) preferably has 1 to 15 alkoxysilyl groups per molecule. When the number of alkoxysilyl groups is less than 1, the primer coating film obtained will be poor in adhesion and water resistance. When it is more than 15, the hydrophilicity will become excessive and poor storage stability will result. The number of epoxy groups is preferably 2 to 10 per molecule, and the epoxy equivalent is preferably within the range from a lower limit of 100 to an upper limit of 800. When the epoxy equivalent is less than 100, the primer coating film obtained will be excessively hard and poor weathering resistance will result and, when it exceeds 800, the curability will become insufficient.

Preferably, the alkoxysilyl group- and epoxy group-containing resin (A) further has 1 to 12 hydroxyl groups and preferably has a hydroxyl value of 5 to 200 mg KOH/g. When the hydroxyl value is lower than 5 mg KOH/g, poor adhesion will result and, then it is higher than 200 mg KOH/g, the water resistance of the primer coating film obtained will be unsatisfactory. Particularly preferred is alkoxysilyl group- and epoxy group-containing resins (A) having, in each molecular, 4 to 10 hydroxyl groups, 3 to 8 epoxy groups, a hydroxyl value of 10 to 150 mg KOH/g and an epoxy equivalent of 200 to 600. In the present specification, the acid value and hydroxyl value each is a value based on the solids, and the number average molecular weight (Mn) is a number average molecular weight on the polystyrene equivalent basis as determined by GPC (gel permeation chromatography).

The primer to be used in the practice of the invention preferably contains the above-mentioned alkoxysilyl group- and epoxy group-containing resin (A) in an amount within the range from a lower limit of 3% by weight to an upper limit of 30% by weight relative to the whole resin component amount in the primer. At content levels lower than 3% by weight, poor adhesion and water resistance will result. At content levels exceeding 30% by weight, poor storage stability will result.

The other components than the alkoxysilyl group- and epoxy group-containing resin (A) in the primer are not particularly restricted but mention may be made of alkoxysilyl group- and epoxy group-free, ordinary resin components, for instance. As the ordinary resin components, there may be mentioned, among others, combinations of a hydroxyl group-containing acrylic resin or polyester resin and a melamine curing agent.

The above-mentioned hydroxyl group-containing acrylic resin is not particularly restricted but may be one obtained by copolymerizing a hydroxyl group-containing acrylic monomer and another ethylenically unsaturated group-containing monomer in the conventional manner, for instance.

The other ethylenically unsaturated group-containing monomer is not particularly restricted but includes, among others, those other monomers (A-4) mentioned hereinabove and, further, epoxy group-containing monomers such as glycidyl(meth)acrylate. These may be used singly or two or more of them may be used in combination.

The above-mentioned polyester resin is not particularly restricted but includes, among others, the products obtained in the conventional manner by polycondensation of an acid component mainly comprising a polycarboxylic acid and an alcohol component mainly comprising a polyhydric alcohol.

The acid component is not particularly restricted but includes, among others, terephthalic acid, isophthalic acid, phthalic acid, and anhydrides thereof; aromatic dicarboxylic acids such as 2,6-naphthalenedicarboxylic acid, 2,7-naphthalenedicarboxylic acid and the like, and anhydrides thereof; aliphatic dicarboxylic acids such as succinic acid, adipic acid, azelaic acid, sebacic acid, dodecanedicarboxylic acid and 1,4-cyclohexanedicarboxylic acid, and anhydrides thereof; lactones such as γ-butyrolactone and ε-caprolactone; aromatic oxymonocarboxylic acids such as ρ-oxyethoxybenzoic acid; at least tribasic polycarboxylic acids such as trimellitic acid, trimesic acid and pyromellitic acid; and hydroxycarboxylic acids corresponding to these. These may be used singly or two or more of them may be used in combination.

The alcohol component is not particularly restricted but includes, among others, ethylene glycol, 1,3-propanediol, 1,4-butanediol, 1,5-pentanediol, 1,5-hexanediol, diethylene glycol, triethylene glycol, 1,4-cyclohexanediol, 1,4-cyclohexanedimethanol, bisphenol A-alkylene oxide adducts, bisphenol S-alkylene oxide adducts; 1,2-propanediol, neopentyl glycol, 1,2-butanediol, 1,3-butanediol, 1,2-pentanediol, 2,3-pentanediol, 1,4-pentanediol, 1,4-hexanediol, 2,5-hexanediol, 3-methyl-1,5-pentanediol, 1,2-dodecanediol, 1,2-octadecanediol and like side chain-containing aliphatic glycols; and at least trihydric polyhydric alcohols such as trimethylolpropane, glycerol and pentaerythritol. These may be used singly or two or more of them may be used in combination.

The above-mentioned hydroxyl group-containing acrylic resin or the above-mentioned polyester resin preferably has an acid value of not higher than 100 mg KOH/g. When the acid value is higher than 100 mg KOH/g, the hydroxyl group-containing acrylic resin or the polyester resin will show an excessively high viscosity and become difficult to handle and, thus, it becomes difficult to prepare a high solid content primer. The acid value is more preferably 2 to 50 mg KOH/g.

The hydroxyl group-containing acrylic resin or the polyester resin preferably has a hydroxyl value of 5 to 200 mg KOH/g. When the hydroxyl value is lower than 5 mg KOH/g, the primer curability will be insufficient and, when it is higher than 200 mg KOH/g, the water resistance of the primer coating film obtained will decrease. The hydroxyl value is more preferably 30 to 200 mg KOH/g.

The hydroxyl group-containing acrylic resin or the polyester resin preferably has a number average molecular weight (Mn) of 500 to 30000. When the number average molecular weight (Mn) is lower than 500, the strength and water resistance of the primer coating film obtained will be low and, when it exceeds 30000, the hydroxyl group-containing acrylic resin or the polyester resin will show an excessively high viscosity and become difficult to handle and, thus, it becomes difficult to prepare a high solid content primer. The number average molecular weight (Mn) is more preferably 500 to 25000.

The hydroxyl group-containing acrylic resin or the polyester resin preferably has a glass transition temperature (Tg) of −20° C. to 60° C. When the glass transition temperature (Tg) is lower than −20° C., the primer coating film obtained will be soft and weak and, when it is higher than 60° C., the primer coating film tends to become uneven and, further, tends to become excessively hard, possibly causing cracking. The glass transition temperature (Tg) is more preferably 0 to 40° C.

The above-mentioned melamine curing agent is preferably an amino resin and/or a blocked polyisocyanate compound. The amino resin is not particularly restricted but may be a melamine resin, a benzoguanamine resin, a glycoluril resin, or a urea resin, for instance. These may be used singly or two or more of them may be used in combination. Among them, the melamine resin and benzoguanamine resin are generally used.

The melamine resin may be converted to alkyl etherified melamine resins by alkyl etherification, and methoxy group- and/or butoxy group-substituted melamine resins are preferred among others.

Among the methoxy group- and/or butoxy group-substituted melamine resins, there may be mentioned Cymel 325, Cymel 327 and Cymel 370 as singly methoxy group-containing ones, Cymel 202, Cymel 204, Cymel 232, Cymel 235, Cymel 236, Cymel 238, Cymel 254, Cymel 266 and Cymel 267 (all trademarks, products of Mitsui Cytec Ltd.) as methoxy group/butoxy group mixed type ones, and Mycoat 506 (trade mark, product of Mitsui Cytec Ltd.), U-Van 20N60 and U-Van 20SE (both trademarks, products of Mitsui Chemicals, Inc.) as singly butoxy group-containing ones. These may be used singly or two or more of them may be used in combination. As for the above-mentioned benzoguanamine resins as well, similarly substituted ones may also be used.

The blocked polyisocyanate compound is a polyisocyanate compound blocked with a blocking agent. The polyisocyanate compound is not particularly restricted but may be any of those compounds which have at least two isocyanato groups within each molecule thereof, including, among others, aliphatic diisocyanates such as hexamethylene diisocyanate (HMDI) and trimethylhexamethylene diisocyanate (TMDI); alicyclic diisocyanates such as isophoronediisocyanate (IPDI); araliphatic diisocyanates such as xylylene diisocyanate (XDI); aromatic diisocyanates such as tolylene diisocyanate (TDI) and 4,4′-diphenylmethanediisocyanate (MDI); hydrogenated diisocyanates such as dimer acid diisocyanate (DDI), hydrogenated TDI (HTDI), hydrogenated XDI (H6XDI) and hydrogenated MDI (HI2MDI); dimers, trimers and further higher-molecular-weight polyisocyanates derived from these diisocyanate compounds; and adducts thereof with polyhydric alcohols such as trimethylolpropane or water or low-molecular-weight polyester resins. These may be used singly or two or more of them may be used in combination.

The blocking agent is not particularly restricted but includes, among others, oximes such as methyl ethyl ketoxime, acetoxime, cyclohexanone oxime, acetophenone oxime and benzophenone oxime; phenols such as m-cresol and xylenol; alcohols such as methanol, ethanol, butanol, 2-ethylhexanol, cyclohexanol and ethylene glycol monoethyl ether; lactams such as ε-caprolactam; diketones such as diethyl malonate and acetoacetate esters; mercaptans such as thiophenol; ureas such as thiourea; imidazoles; and carbamic acids. These may be used singly or two or more of them may be used in combination.

The method of blocking polyisocyanate compounds with a blocking agent is not particularly restricted but, for example, mention may be made of the method comprising carrying out the reaction in the conventional manner until there is no more free isocyanato group remaining.

Usable as the blocked polyisocyanate compound are such commercial products as Desmodur (trademark) series ones (products of Sumitomo Bayer Urethane Co., Ltd.), Burnock D (trademark) series ones (products of Dainippon Ink and Chemicals, Inc.), Takenate B (trademark) series ones (products of Takeda Chemical Industries, Ltd.), Coronate 2500 (trademark) series ones (products of Nippon Polyurethane Industry Co., Ltd.) and so on. Among these, oxime-, lactam- or diketone-blocked ones are preferred.

The primer to be used in the practice of the invention is preferably formulated so that an amount of the isocyanato group not smaller than the amount equivalent to the hydroxyl value of the hydroxyl group-containing acrylic resin or polyester resin may be contained therein. More specifically, the melamine curing agent is preferably incorporated in an amount such that the weight ratio between the hydroxyl group-containing acrylic resin or polyester resin and the melamine curing agent may be 8/2 to 5/5, more preferably 7/3 to 6/4. In the case of a polyisocyanate compound, the amount thereof may be within the range of 0.8 to 1.5 times the amount equivalent to the above-mentioned hydroxyl value. When that amount is smaller than 0.8 times the amount equivalent to the hydroxyl value, the curability of the primer coating film will be unsatisfactory, giving only a soft and weak primer coating film; not only the hardness but also the chemical resistance and contamination resistance of the primer coating film will be low. When it exceeds 1.5 times, the polyisocyanate compound added in excess will not produce any further effect but, rather, the strength, hardness and chemical resistance, among others, of the primer coating film will become decreased; the yellowing resistance and weathering resistance also tend to lower. A preferred level is 1.0 to 1.2 times.

The melamine curing agent is generally used in combination with a curing catalyst. The curing catalyst to be used when the above-mentioned blocked polyisocyanate compound is used as a melamine curing agent is not particularly restricted but includes, among others, organotin compounds such as dibutyltin dilaurate, dibutyltin octoate and dibutyltin diacetate; and metal chelate compounds such as aluminum tris(acetylacetonate), titanium tetrakis(acetylacetonate), titanium bis(acetylacetonate), bis(butoxy)titanium bis(acetylacetonate), bis(isopropoxy)titanium bis(acetylacetonate), bis(butoxy)zirconium bis(acetylacetonate) and bis(isopropoxy)zirconium bis(acetylacetonate). These may be used singly or two or more of them may be used in combination. Among these, organotin compounds are generally used.

In cases where the above-mentioned amino resin is used as a melamine curing agent, use may be made of such curing catalysts as aromatic sulfonic acids such as dodecylbenzenesulfonic acid, dinonyinaphthalenesulfonic acid and ρ-toluenesulfonic acid; organic phosphonic acids such as aminotri(methylenephosphonic acid), 1-hydroxyethylidene-1,1-diphosphonic acid; amine salts of these. These may be used singly or two or more of them may be used in combination. The level of addition of such curing catalysts is preferably 0.01 to 3.0% by weight relative to the total resin solids.

In the primer, there may be incorporated a melamine-formaldehyde resin for increasing the crosslink density and improving the water resistance, an ultraviolet absorber or light stabilizer or the like for improving the weathering resistance of the primer coating film, a microgel or surface modifier for rheology control, and/or a diluent for viscosity adjustment.

The ultraviolet absorber or light stabilizer is not particularly restricted but includes, among others, Tinuvin 900 (product of Ciba-Geigy) and Sanol LS-292 (product of Sankyo Co., Ltd.). The diluent is not particularly restricted but includes, among others, alcohol solvents such as methanol, ethanol, propanol and butanol; hydrocarbons, esters and like solvents. These may be used singly or two or more of them may be used in combination. The level of addition of the diluent is preferably not higher than the upper limit of 60% by weight, more preferably within the range of 20 to 55% by weight, relative to the total primer weight after addition of the diluent.

The primer may contain a pigment unless the feeling of transparency of the primer coating film is impaired and unless the color tone of the base coating film and so on are adversely affected. The level of addition of the pigment is preferably not higher than 10% by weight relative to the whole solids in the primer.

The pigment is not particularly restricted but can includes, among others, iron oxide, lead oxide, carbon black, coal dust, titanium dioxide, talc, barium sulfate, cadmium yellow, cadmium red, chrome yellow, metal pigments (e.g. aluminum flakes), organic pigments (e.g. phthalocyanine blue, Cinquacia red), pearl mica, etc. These may be used singly or two or more of them may be used in combination.

The method of preparing the primer is not particularly restricted. For example, the primer can be prepared by stirring the components mentioned above using an agitator, for instance. When the primer contains a pigment such as mentioned above, the primer can also be prepared by kneading using a kneader or roll, for instance. The solid content of the primer is preferably within the range from a lower limit of 25% by weight to an upper limit of 70% by weight. The lower limit is more preferably 35% by weight, and the upper limit is more preferably 65% by weight. The solids content at the time of application is preferably within the range from a lower limit of 10% by weight to an upper limit of 65% by weight, and the lower limit is more preferably 15% by weight, and the upper limit is more preferably 50% by weight.

The method of applying the above primer is not particularly restricted but the application can be carried out using an air electrostatic sprayer commonly called “react gun”; or a rotary sprayer type electrostatic spray coater commonly called “Micro Micro (μμ) Bell”, “Micro (μ) Bell” or “MetaBell”. The dry film thickness of the primer coating film obtained from the above-mentioned primer is preferably within the range from a lower limit of 5 μm to an upper limit of 30 μm. The upper limit is more preferably 15 μm, and the lower limit is more preferably 7 μm. When the dry film thickness is less than 5 μm, no satisfactory adhesion to the powder clear coating composition can be attained. On the other hand, when the film thickness exceeds 30 μm, such troubles as sagging and popping may occur on the occasion of application.

The powder clear coating composition to be used in the practice of the invention may be a ground powder coating composition obtained by grinding a melt-kneaded raw material or a powder clear coating composition known in the art, such as a suspension-derived powder coating composition obtained by emulsion polymerization or suspension polymerization, for instance. From the finished coat appearance viewpoint, however, a suspension-derived powder coating composition is preferred.

The powder clear coating composition comprises a film-forming resin. The film-forming resin is not particularly restricted but may be any of those generally used in the field of powder coating compositions. More specifically, there may be mentioned thermosetting resins. The thermosetting resins are not particularly restricted but can include, among others, thermosetting acrylic resins and thermosetting polyester resins.

When such a thermosetting resin as mentioned above is used as the film-forming resin, the composition preferably contains a curing agent and a curing promoter. As preferred combinations, there may be mentioned the following examples.

When a thermosetting, glycidyl group-containing acrylic resin, for instance, is used as the film-forming resin, a polycarboxylic acid, for instance, can be used as the curing agent. When a thermosetting polyester resin is used as the film-forming resin, a blocked isocyanate compound, for instance, can be used as the curing agent.

As the suspension-derived powder coating composition, there may be mentioned, for example, a thermosetting powder coating composition obtained by preparing a suspension by dispersing a thermosetting resin solution comprising a thermosetting resin and an organic solvent in an aqueous solution containing a water-soluble polymer, distilling off the organic solvent from the dispersed phase of the suspension to solidify the dispersed phase and separating the solidified dispersed phase particles from the suspension and characterized in that the thermosetting resin solution contains a resin (F) and a resin (G) as the thermosetting resin, the resin F and resin G satisfy the conditions (a) that the difference (SP value of resin F)−(SP value of resin G) be 0.1 to 1.0, (b) that the resin F have a glass transition temperature of 50 to 100° C. and a number average molecular weight of 2000 to 4000 and the value of the ratio (number average molecular weight/100+ glass transition temperature) be not lower than 90, (c) that the resin G have a glass transition temperature of 20 to 70° C. and a number average molecular weight of 1000 to 4000 and the value of the ratio (number average molecular weight/100+glass transition temperature) be not higher than 89 and (d) that the resin F/resin G solids ratio by weight is 5/95 to 50/50, and in that the viscosity of the thermosetting powder coating composition in a temperature raising test up to 140° C. be not higher than 40 mPa.sec. Since the SP value of resin F is higher than the SP value of resin G, as mentioned above, the resin F occupies a relatively outer position in each dispersed phase particle and the resin G occupies a relatively inner position in each particle. Since the resin F has a (number average molecular weight/100+glass transition temperature) value of not lower than 90 and the resin G has a (number average molecular weight/100+glass transition temperature) value of not higher than 89, as mentioned above, the resin F is a harder resin as compared with the resin G. Therefore, the relatively soft resin G is surrounded by the relatively hard resin F in each particle of the thermosetting powder coating composition. As a result, the composition is excellent in blocking resistance and, at the same time, the melt viscosity of each particle as a whole is low, hence the resulting coating film shows good smoothness.

When the difference in SP value between the resin F and resin G is smaller than 0.1, the blocking resistance during storage decreases. When the difference in SP value is greater than 1.0, the compatibility between the resin F and resin G becomes poor and the coat appearance obtained will become deteriorated.

When the glass transition temperatures and number average molecular weights of the resin F and resin G are lower than the respective ranges given above, the blocking resistance may possibly decrease. When they are higher than the respective ranges given above, the melt viscosity increases and the coat appearance may possibly deteriorate. When the glass transition temperatures and number average molecular weights of the resin F and resin G are outside the above respective ranges, the mutual compatibility between the resin F and resin G becomes poor, so that the coat appearance may possibly deteriorate.

The resin F/resin G solids weight ratio is 5/95 to 50/50. As the content of the resin F decreases, the blocking resistance possibly tends to decrease. With the increase in resin F content, the melt viscosity increases and the coat appearance may possibly be deteriorated.

The viscosity of the above-mentioned thermosetting powder coating composition in a temperature raising test up to 140° C. is preferably not higher than 40 mPa.sec. When this viscosity is higher than this range, no good film smoothness will be obtained and the coat appearance may possibly be deteriorated.

The viscosity of the resin F in a temperature raising test up to 140° C. is preferably not lower than 500 mPa.sec. When this viscosity is lower than this range, the blocking resistance may possibly decrease.

The viscosity of the resin G in a temperature raising test up to 140° C. is preferably not higher than 300 mPa.sec. When this viscosity is higher than this range, the melt viscosity increases and the coat appearance may possibly be deteriorated.

The above-mentioned curing agent is preferably contained in the thermosetting resin solution in the form of a solid. As preferred specific examples of the resin F and resin G, there may be mentioned epoxy group-containing acrylic resins. As the curing agent, there may be mentioned carboxylic acid group- or carboxylic acid anhydride group-containing compounds.

The epoxy group-containing acrylic resins mentioned above are not particularly restricted but, specifically, each may be an acrylic resin containing two or more epoxy groups within each molecule. Thus, for example, mention may be made of those obtained by polymerization, in the conventional manner, of an epoxy group-containing monomer, such as glycidyl acrylate, glycidyl methacrylate and 2-methylglycidyl methacrylate, as an essential component, and a monomer unreactive with the epoxy group-containing monomer, for example methyl(meth)acrylate, ethyl(meth)acrylate, n-butyl(meth)acrylate, iso-butyl(meth)acrylate, tert-butyl(meth)acrylate, hydroxyethyl(meth)acrylate, hydroxypropyl(meth)acrylate, hydroxybutyl acrylate, styrene, vinyltoluene and ρ-chlorostyrene.

The resin solids in the epoxy group-containing acrylic resin have an epoxy equivalent of 100 to 1000 g/eq, preferably 150 to 600 g/eq, more preferably 200 to 400 g/eq. When the epoxy equivalent is lower than 100 g/eq, the storage stability of the coating composition obtained may possibly decrease. When the epoxy equivalent is higher than 1000 g/eq, the performance of the coating film obtained may possibly be deteriorated.

As the curing agent, there may be mentioned polycarboxylic acid compounds which occur as crystalline solids at room temperature.

The term “room temperature” as used herein means 25° C. As the polycarboxylic acid compounds are not particularly restricted but specifically include, among others, polycarboxylic acid compounds such as aliphatic polycarboxylic acids and aromatic polycarboxylic acids, and acid anhydride compounds derived therefrom.

The aliphatic polycarboxylic acid compounds are not particularly restricted but include, among others, decanedicarboxylic acid, adipic acid, maleic acid, malonic acid, ethylmalonic acid, butylmalonic acid, dimethylmalonic acid, succinic acid, methylsuccinic acid, dimethylsuccinic acid, glutaric acid, methylglutaric acid, dimethylglutaric acid, sabacic acid, azelaic acid, pimelic acid, suberic acid, 1,11-undecanedioic acid, dodecanedicarboxylic acid, hexadecanedicarboxylic acid, 3-isooctylhexanedicarboxylic acid, cyclohexanedicarboxylic acid, butanetricarboxylic acid, butanetetracarboxylic acid, citric acid and tricarballylic acid. Usable as the aromatic polycarboxylic acids are, for example, phthalic acid and the like. As the acid anhydride compounds derived from these, there may be mentioned succinic anhydride, tetrahydrophthalic anhydride and phthalic anhydride, among others.

In addition to the polycarboxylic acid compounds enumerated above, those synthetically prepared polycarboxylic acid compounds which occur as crystalline solids at room temperature can also be used. As specific examples of such synthetic polycarboxylic acid compounds, there may be mentioned those obtained by reacting a polyhydric alcohol with an acid anhydride, for example butanediol succinate obtained from butanediol and succinic anhydride, hexanediol succinate obtained from hexanediol and succinic anhydride, nonanediol succinate obtained from nonanediol and succinic anhydride, and the neopentyl glycoltrimellitic anhydride-succinic anhydride 1:1:1 adduct, for instance.

The curing agent may be a mixture of such a polycarboxylic acid compound as mentioned above and a carboxylic acid compound different in kind from the polycarboxylic acid compound. As this carboxylic acid compound different in kind, there may be mentioned not only those polycarboxylic acid compounds occurring as crystalline solids at room temperature mentioned above referring to the polycarboxylic acids but also polycarboxylic acid compound occurring as noncrystalline solids or liquids at room temperature and monocarboxylic acid compounds not restricted in form at room temperature, among others. More specifically, use may be made of aliphatic monocarboxylic acids such as sebacic acid, lauric acid, stearic acid and 8-ethyloctadecanoic acid, as well as nonanediol-hexahydrophthalic anhydride 1:2 adduct and like ones occurring as liquids at room temperature. The above-mentioned carboxylic acid compound may also comprise two or more species.

The method of mixing a polycarboxylic acid compound and a carboxylic acid compound different in kind from this polycarboxylic acid compound is not particularly restricted but preferably comprises mixing after reducing the respective particle diameters, or dissolving them in a solvent or the like, followed by mixing.

The mole ratio between the carboxyl group of the curing agent and the epoxy group of the epoxy group-containing acrylic resin is preferably 5/10 to 11/10, more preferably 7/10 to 10/10. When that mole ratio is outside the above range, the curability of the coating film obtained may be insufficient. In the above-mentioned thermosetting powder coating composition, there may be incorporated one or more of pigments, various additives and so forth according to need. As specific examples of the pigments, there may be mentioned titanium dioxide, red iron oxide, yellow iron oxide, carbon black, phthalocyanine blue, phthalocyanine green, quinacridone pigments, azo pigments and other color pigments as well as talc, silica, calcium carbonate, precipitated barium sulfate and other extender pigments.

As the additives, there may specifically be mentioned flow modifiers such as Aerosil 130 and Aerosil 200 (products of Nippon Aerosil Co., Ltd.), surface modifiers such as dimethylsilicone, methylsilicone and other silicones, acrylic oligomers, benzoin, benzoin derivatives and other benzoins, curing promoters (or curing catalysts), antistatic agents, ultraviolet absorbers, antioxidants, and pigment dispersants, among others.

The volume average particle diameter of the thermosetting powder coating composition is not particularly restricted but, from the production efficiency and resulting film smoothness viewpoint, it is preferably 5 to 30 μm. When the volume average particle diameter is smaller than 5 μm, the production efficiency and the coating efficiency in the step of application may possibly decrease. When that diameter is larger than 30 μm, the smoothness of the coating film obtained may possibly deteriorate.

The above-mentioned thermosetting powder coating composition producing method is a method by which the above-mentioned thermosetting powder coating composition can be produced and is characterized in that it comprises preparing a suspension by dispersing a thermosetting resin solution comprising a thermosetting resin and an organic solvent in an aqueous solution containing a water-soluble polymer, distilling off the organic solvent in the dispersed phase of the suspension to thereby solidify the dispersed phase and separating the solidified dispersed phase particles from the suspension.

As for the organic solvent, one which is immiscible with water, namely one whose solubility in water is not higher than 10% by weight, is preferably used. Thus, for example, xylene, toluene, cyclohexane, ethyl acetate and the like can be used.

The weight of the resin solids in the thermosetting resin solution is not particularly restricted but the solution is preferably prepared so that the weight in the solution may amount to 10 to 90% by weight. A suspension is prepared by dispersing the thermosetting resin solution in an aqueous solution containing a water-soluble polymer. In the suspension, the thermosetting resin solution is dispersed and a dispersed phase is formed. The particle diameter of the particles in this dispersed phase can be controlled by various methods. For example, the particle diameter of the dispersed phase particles can be controlled by utilizing the cloud point of the water-soluble polymer. In this case, at least two water-soluble polymers, one showing no cloud point and the other showing a cloud point within the range of 30 to 90° C., are used.

As specific examples of the water-soluble polymer showing no cloud point, there may be mentioned completely saponified polyvinyl alcohol, partially saponified polyvinyl alcohol with a degree of saponification of not lower than 85%, ethylcellulose, hydroxyethylcellulose, polyethylene glycol and others showing no cloud point phenomenon at 100° C. and below. Such water-soluble polymers showing no cloud point may be used singly or two or more of them may be used in combination.

As specific examples of the water-soluble polymer showing a cloud point within the range of 30 to 90° C., there may be mentioned partially saponified polyvinyl alcohol with a degree of saponification lower than 85%, partially formalized derivatives thereof, ethylene-vinyl alcohol copolymers and like partially hydrophobic group-containing polyvinyl alcohol-based polymers, methylcellulose, hydroxypropylcellulose and like cellulose derivatives, polyethylene glycol alkyl ethers, ethylene glycol-propylene glycol block copolymers and other polymers showing a cloud point phenomenon within the range of 30 to 90° C. upon warming of aqueous solutions thereof. In addition, there may be mentioned water-soluble polymers not showing the above-specified cloud point by nature but provided with a cloud point within the range of 30 to 90° C. by addition of an electrolyte.

The water-soluble polymer concentration in the aqueous solution is preferably about 0.02 to 20% by weight. The solid weight ratio between the water-soluble polymer showing no cloud point and the water-soluble polymer showing a cloud point within the range of 30 to 90° C. is preferably within the range of 99/1 to 10/90. In cases where the particle diameter is controlled by the cloud point technique, the thermosetting powder coating composition is preferably produced by the following steps (1) to (3):
(1) Step of suspension preparation at a temperature lower than the cloud point: The above-mentioned suspension is prepared at a temperature lower than the cloud point. In cases where two or more water-soluble polymer species showing a cloud point within the range of 30 to 90° C., the lower cloud point is given preference. When, for suspension preparation, respective thermosetting resin solutions of the resin F and resin G are separately prepared at a temperature lower than the lowest cloud point among the water-soluble polymers employed, they may be added to the aqueous water-soluble polymer solution but, preferably, the respective thermosetting resin solution are mixed up before addition to give one solution and then this is added the aqueous water-soluble polymer solution.
(2) Step of raising the temperature of the suspension within a temperature range lower than the cloud point to form primary particles of the dispersed phase: Primary particles of the dispersed phase are formed by raising the temperature within a temperature range lower than the cloud point. The volume average particle diameter of the primary particles on that occasion is preferably not larger than 15 μm. The particle diameter of the primary particles can be measured by arbitrary sampling.
(3) Step of raising the temperature of the primary particle-containing suspension to a temperature not lower than the cloud point to thereby cause aggregation of the primary particles to form secondary particles and distilling off the organic solvent in the secondary particles out of the system to solidify the particles: Primary particles are caused to aggregate to form secondary particles by raising the temperature to a level not lower than the cloud point. By doing so, the particle diameter is adjusted to a desired particle diameter. The particles are solidified by distilling off the organic solvent in the secondary particles out of the system, and the solidified particles are separated from the suspension. The removal of the organic solvent by distillation can be effected by raising the temperature and/or reducing the pressure. Since the particles contain the thermosetting resin(s), the temperature at which the organic solvent is distilled off is preferably as low as possible. From such viewpoint, the organic solvent is preferably distilled off under reduced pressure at a relatively low temperature.

Preferably, the organic solvent is partially distilled off in advance in step (2). As for the method of removal by distillation, the organic solvent is preferably distilled off at a relative low temperature while placing the system under reduced pressure, like in step (3). Preferably, the organic solvent is distilled off until the amount thereof in the dispersed phase particles amounts to 30% by weight or less.

The thus-obtained solidified particles can be separated by an ordinary solid-liquid separation method such as filtration or centrifugation. After separation, the particles are washed with water and dried to give the final thermosetting powder coating composition.

In cases where the cloud point is not utilized, the thermosetting powder coating composition can be produced by preparing a suspension at a temperature lower than the cloud point, distilling off the organic solvent in the dispersed phase to solidify the dispersed phase, and separating the solidified dispersed phase particles from the suspension. The water-soluble polymer to be used may be a water-soluble polymer showing no cloud point or a water-soluble polymer showing a cloud point within the range of 30 to 90° C., or a mixture of these.

The method of applying the above powder clear coating composition is not particularly restricted but preferably comprises applying using the above-mentioned electrostatic coater. The thickness of the clear coating film obtained from the above powder clear coating composition is preferably within the range from a lower limit of 30 μm to an upper limit of 80 μm. The upper limit is more preferably 60 μm, and the lower limit is more preferably 40 μm. When the film thickness is less than 30 μm, the unevenness resulting from the base coating film and so forth cannot be hidden. On the other hand, when the thickness exceeds 80 μm, troubles, for example popping, may occur in some instances in the step of application.

The water-borne intermediate coating composition to be used in the practice of the invention is not particularly restricted but, for example, those intermediate coating compositions known in the art, for example those of the melamine-curable type or of the isocyanate-curable type, can be used. More specifically, there may be mentioned, for example, water-borne intermediate coating compositions characterized in that they comprise, as the main components, (D) a polyester resin having an acid value of 10 to 100, a hydroxyl value of 20 to 300 and a number average molecular weight of 800 to 10000 and (E) a water-borne amino resin.

The component (D) is a polyester resin having an acid value of 10 to 100, a hydroxyl value of 20 to 300 and a number average molecular weight of 800 to 10000. As the polyester resin, there may be mentioned, among others, oil-free polyester resins resulting from condensation of any of alcohol components with any of acid components, namely the alcohol component selected from among polyhydric alcohols such as ethylene glycol, diethylene glycol, propylene glycol, butanediol, pentanediol, 2,2-dimethylpentanediol, glycerol, trimethylolpropane and pentaerythritol, if necessary together with a monohydric alcohol or a monoepoxy compound having one glycidyl group within the molecule (e.g. Cardura E (trademark, product of Shell Chemical Company)), the acid component selected from among polybasic acids such as phthalic anhydride, isophthalic acid, tetrahydrophthalic anhydride, hexahydrophthalic anhydride, maleic anhydride, succinic anhydride, adipic acid, sebacic acid, trimellitic anhydride and pyromellitic anhydride, if necessary together with a monobasic acid such as benzoic acid or tert-butylbenzoic acid; or oil-modified polyester resins obtained by reacting three components together, an oil component selected from among, in addition to the above-mentioned alcohol component and acid component, castor oil, dehydrated castor oil, tung oil, safflower oil, soybean oil, linseed oil, tall oil, coconut oil, etc., and fatty acids thereof or mixtures of two or more of them. Acrylic resin-grafted polyester resins and urethane-modified polyester resins can also be used as the component (D).

The above-mentioned component (D) has an acid value of 10 to 100, preferably 15 to 50, and a hydroxyl value of 20 to 300, preferably 50 to 250. At acid value levels lower than 10, the thinning with water unfavorably becomes unsatisfactory. At hydroxyl value levels lower than 20, the curability becomes insufficient and, when the acid value is above 100 and the hydroxyl value is above 300, the water resistance and chemical resistance of the coating film unfavorably decrease. Further, the number average molecular weight of the component (D) is preferably 800 to 10000, more suitably 1000 to 8000. When the number average molecular weight is lower than 800, the hardness and water resistance of the coating film decrease and, when it is higher than 10000, the atomization for electrostatic coating becomes difficult to perform and the film smoothness unfavorably deteriorate.

A basic substance is added to the component (D) to neutralize at least 50% of the carboxyl groups for use in a water-borne form.

The above-mentioned component (E) is a water-borne amino resin. This serves as a crosslinking agent for the component (D) and, for example, there may be mentioned di-, tri-, tetra-, penta- and hexamethylolmelamine and methyl etherification derivatives thereof, urea-formaldehyde condensates, and urea-melamine cocondensates.

The component (E) is hydrophilic to such an extent that it can dissolve in water or remain in stably dispersed condition without undergoing phase separation or precipitating in water. Preferred as the component (E) is melamine among those mentioned above.

The water-borne intermediate coating composition comprising the above components (D) and (E) preferably contains an inorganic pigment such as titanium oxide, barium sulfate, calcium carbonate or clay for the improvement in workability and for the improvement in film thickness retention and physical strength, for instance, of the intermediate coating film obtained and, further, any of various pigments for coloration, in a total amount of 1 to 200 parts by weight relative to 100 parts by weight of the total resin solids of the components (D) and (E). The method of applying the intermediate coating composition is not particularly restricted but the composition can be suitably applied using the above-mentioned electrostatic coater.

The dry film thickness of the intermediate coating film is preferably 20 to 40 μm, although it may vary according to the field of application. When the upper limit is exceeded, the mirror sharpness may deteriorate or such a trouble as sagging in the step of application and/or popping in the step of baking may occur in some instances and, when the thickness is less than the lower limit, the appearance may possibly deteriorate.

The water-borne base coating composition to be used in the practice of the invention is not particularly restricted but, for example, there may be mentioned one comprising a film-forming resin, a curing agent, a pigment and one or more other additives. The film-forming resin is not particularly restricted but includes, among others, acrylic resins, polyester resins, alkyd resins, epoxy resins and urethane resins. These are used in combination with a curing agent such as an amino resin and/or a blocked isocyanate resin. From the pigment dispersibility and workability viewpoint, the combination of an acrylic resin and/or a polyester resin and a melamine resin is preferred.

The water-borne base coating composition may be used as a metallic base coating composition after incorporation of a luster pigment or as a solid type base coating composition after incorporation of a red, blue, black or other color pigment and/or an extender pigment without adding any luster pigment. More specifically, there may be mentioned Aquarex 2000 (trademark; water-borne base coating composition, product of Nippon Paint Co., Ltd.), etc.

The method of applying the above water-borne base coating composition is not particularly restricted. When the substrate is an automotive body or the like, the coating composition is preferably applied in the manner of multistage application, preferably two-stage application, by air electrostatic spraying, or by the method comprising combining air electrostatic spraying with the use of the above-mentioned rotary sprayer type electrostatic spray coater so that the design characteristics may be improved.

The dry film thickness of the base coating film is preferably 5 to 35 μm, although it may vary according to the field of application. When the upper limit is exceeded, the mirror sharpness may deteriorate or such a trouble as mottling and/or sagging in the step of application may occur in some instances and, when the thickness is less than the lower limit, color-unevenness may possibly appear.

The substrate on which the multilayer coating film is formed in accordance with the present invention is one having a cationically electrodeposited coating film. The cationically electrodeposited coating film is not particularly restricted but may be one obtained by using any of the cationic electrocoating compositions known in the art. The substrate is not particularly restricted but can include, among others, metals, plastics, and foamed articles. Among them, metal products are particularly preferred since cationic electrodeposition can be suitably applied thereto. The metal products are not particularly restricted but there may be mentioned, among others, products made of iron, copper, aluminum, tin, zinc, and alloys comprising these metals. More specifically, bodies and parts of automobiles such as cars, trucks, motorcycles and buses are preferred. These metal products are more preferably subjected in advance to chemical conversion treatment with a phosphate or chromate, for instance.

The invention also relates to a multilayer coating film obtained by the above-mentioned method of forming multilayer coating films.

The method of forming multilayer coating films according to the invention is a method by which the VOC is reduced through the use of a powder clear coating composition. The present invention also makes it possible to form a clear coating film showing good adhesion even on a base coating film cured for removing volatile substances which deteriorate the appearance of the clear coating film.

The method of forming multilayer coating films according to the invention makes it possible to obtain a multilayer coating film which is ecofriendly and will not show any unfavorable change in appearance, such as yellowing. This is because the use of a powder clear coating composition according to the invention leads to reduction in VOC content and the application of a primer makes it possible to form a clear coating film showing good adhesion even on the cured base coating film.

### BEST MODES FOR CARRYING OUT THE INVENTION

The following examples illustrated the invention in further detail. These examples are, however, by no means limitative of the scope of the invention. In the examples, “part(s)” means “part(s) by weight” and “%” means “% by weight”, unless otherwise specified.

### PRODUCTION EXAMPLE 1

Preparation of a Water-Borne White Intermediate Coating Composition

A polyester resin obtained by reacting 19.6 parts of neopentyl glycol, 18.5 parts of trimethylolpropane and 46.7 parts of phthalic anhydride at 180° C. for 7 hours was reacted with 15.7 parts of isophoronediisocyanate at 120° C. and, then, 5.2 parts of trimellitic anhydride was further added and the reaction was allowed to proceed at 180° C. for 1 hour to give a urethane-modified polyester resin with a number average molecular weight of 2350, an acid value of 40 and a hydroxyl value of 100. This was neutralized with an equivalent amount of dimethylethanolamine to give a urethane-modified polyester resin (D1). The polyisocyanate was used in an amount of 17% by weight relative to the polyester resin.

Cymel 703 (trademark; Mitsui Cytec's melamine resin) was used as the water-borne amino component (E1).

A water-borne intermediate coating composition was prepared according to the formulation shown in Table 1. Titanium oxide white was added as a pigment. The pigment was charged into a vessel together with parts of the components and deionized water and dispersed for 1 hour using glass beads as dispersion media so that the particle diameter might amount to not larger than 5 μm as measured with a fineness gage. Diethylene glycol monoethyl ether was used as the organic solvent. The usages of the components (D1) and (E1) are given on the solids basis (parts by weight).

TABLE 1

| | Amount |
|---|---|
| | (parts by weight) |
| (D1) | 70 |
| (E1) | 20 |
| Pigment | 102 |
| Organic solvent | 15 |

### PRODUCTION EXAMPLE 2

Preparation of a Primer (Solvent-Borne)

Hydroxyl Group-containing Acrylic Resin (A3)

A reaction vessel equipped with a thermometer, stirrer, condenser, nitrogen inlet tube and dropping funnel was charged with 400 parts of toluene and 100 parts of n-butanol, and the contents were heated to 105° C. To this reaction vessel was added dropwise over 3 hours, using the dropping funnel, a solution composed of 100 parts of styrene, 300 parts of methyl methacrylate, 440 parts of ethyl acrylate, 140 parts of 2-hydroxyethyl methacrylate, 20 parts of methacrylic acid, 20 parts of tert-butyl perpoxy-2-ethylhexanoate and 300 parts of toluene. After completion of the dropping, the mixture was maintained at 105° C. for 30 minutes and, then, 3 parts of tert-butyl peroxy-2-ethylhexanoate and 200 parts of toluene were added. After completion of this addition, the reaction mixture was maintained at 105° C. for more 2 hours to give a resin solution containing a hydroxyl group-having acrylic resin (A3) with a number average molecular weight (Mn) of 18000, an acid value of 13 mg KOH/g (on solids basis) and a hydroxyl value of 60 mg KOH/g (on solids basis). The nonvolatile matter content was 50%.

Alkoxysilyl Group- and Epoxy Group-containing Acrylic Resin (A4)

The inside of a one-liter reaction vessel equipped with a thermometer, stirrer, condenser and nitrogen inlet tube was purged with nitrogen gas and, after nitrogen substitution, the vessel was charged with 260 parts of Solvesso 100 (aromatic hydrocarbon solvent, product of Esso Standard Oil Company), and the contents were heated to 125° C. To this reaction vessel was added dropwise over 3 hours, using a dropping funnel, a solution composed of 100 parts of styrene, 190 parts of glycidyl methacrylate, 64 parts of 4-hydroxybutyl acrylate, 96 parts of isobutyl methacrylate, 50 parts of γ-methacryloxypropyltrimethoxysilane, 55 parts of tert-butyl peroxy-2-ethylhexanoate and 55 parts of Solvesso 100. After completion of the dropping, the mixture was maintained at 125° C. for 30 minutes and, then, a solution composed of 5 parts of tert-butyl peroxy-2-ethylhexanoate and 10 parts of Solvesso 100 was added dropwise over 30 minutes. After completion of this dropping, the reaction was further continued at 125° C. for 1 hour to give a resin solution containing an acrylic resin (A4) with a number average molecular weight of 3000, an epoxy equivalent of 374 (on solids basis), a hydroxyl value of 50 mg KOH/g (on solids basis) and an alkoxysilyl group-containing monomer content of 10% by weight. The nonvolatile matter content was 59%.

A primer (solvent-borne type) to be used in the practice of the invention was obtained by charging the components specified in Table 2 and stirring them with a Disper agitator. In the table, U-Van 20N-60 (trademark, product of Mitsui Chemicals, Inc.) is a melamine resin with a nonvolatile matter content of 60%, and the surface modifier 1 is Modaflow (trademark, product of Monsanto Co.).

TABLE 2

| | Amount |
|---|---|
| | (parts by weight) |
| Resin A3 solution (solids 50%) | 140 |
| Resin A4 solution (solids 59%) | 17 |
| U-Van 20N-60 | 50 |
| Surface modifier 1 | 1 |
| Xylene | 15 |
| Butanol | 3 |

### PRODUCTION EXAMPLE 3

Preparation of a Primer (Water-Borne Type)

The organic solvents in the resin A3 and resin A4 were distilled off to give solid resins. Using these solid resins as raw materials, a primer (water-borne type) to be used in the practice of the invention was prepared by mixing up the materials specified in Table 3 according to the formulation shown there using a Disper agitator. The surface modifier 2 is BYK-190 (trademark, product of BYK Chemie GmbH).

TABLE 3

| | Amount |
|---|---|
| | (parts by weight) |
| Solid resin A3 | 70 |
| Solid resin A4 | 10 |
| Surface modifier 2 | 1 |
| Deionized water | 53 |

### PRODUCTION EXAMPLE 4

Preparation of Suspension-Derived Powders

(Resin Preparation)

A reaction vessel equipped with a stirrer, temperature adjuster and reflux condenser was charged with 63 parts of xylene, which was then heated to 130° C. Then, a monomer/initiator mixture according to the formulation (F1 or G1) given in Table 4 was added dropwise thereto over 3 hours in a nitrogen atmosphere.

The symbols used in the table are as follows:
GMA: glycidyl methacrylate; St: styrene; MMA: methyl methacrylate; HEMA: 2-hydroxyethyl methacrylate; IBMA: isobutyl methacrylate; TMI: dimethyl m-iso(isopropenyl) benzyl isocyanate; t-BPO: tert-butyl peroctoate; E-CL: ε-caprolactone.

After dropping, the temperature was maintained for 3 hours, followed by cooling to room temperature to give a resin F1 and resin G1. The solids concentration of each resin was adjusted to 65% by weight by distilling off the xylene, for instance.

The SP value, glass transition temperature (Tg) and number average molecular weight (Mn) of each resin were measured.

The SP value was measured by the turbidimetric method. The Tg was measured using a model DSC220C differential scanning calorimeter (product of Seiko Denshi Kogyo KK; temperature raising 5° C./min). The number average molecular weight was determined by GPC (gel permeation chromatography). The characteristic values obtained in the above manner are shown in Table 4.

TABLE 4

| | | | Resin F1 | Resin G1 |
|---|---|---|---|---|
| Formulation | Monomer | GMA | 45 | 45 |
| | (parts by weight) | St | 20 | 20 |
| | | MMA | 27 | 12 |
| | | HEMA | 3 | — |
| | | IBMA | 5 | 18 |
| | | TMI | — | 5 |
| | Initiator | t-BPO | 8 | 7 |
| | (parts by weight) | | | |
| | Blocking agent | E-CL | — | 2.8 |
| | (parts by weight) | | | |
| Characteristics | SP | | 10.5 | 10.2 |
| | Tg(° C.) | | 70 | 39 |
| | Mn | | 3000 | 3500 |

Preparation of a Powder Clear Coating Composition 1 (Suspension-Derived Powder Coating Composition)

(Preparation of a Curing Agent Dispersion)

1,10-Decanedicarboxylic acid (75 parts) and 25 parts of sebacic acid were mixed up, and the mixture was dispersed in xylene and ground in a sand grinding mill to give a curing agent dispersion (solids 30% by weight).

A thermosetting powder coating composition was produced according to the formulation given in Table 5. The materials of the formulation of the coating composition were mixed up in a sand grinding mill, and the thus-prepared material solution was added to an aqueous polymer solution composed of 6 parts of Gohsenol GH-20 (polyvinyl alcohol, degree of saponification 88%, showing no cloud point; product of Nippon Synthetic Chemical Industry Co., Ltd.), 3 parts of Gohsenol KL-05 (polyvinyl alcohol, degree of saponification 80%, cloud point about 80° C.; product of Nippon Synthetic Chemical Industry Co., Ltd.), 1 part of hydroxypropylcellulose (cloud point about 50° C.) and 90 parts of deionized water. The resulting mixture was further stirred at 25° C. using a homogenizer. A suspension containing dispersed phase particles with a volume average particle diameter of 5.0 μm was thus prepared.

The suspension obtained was diluted by addition of 300 parts of deionized water, and the dilution was transferred to a vessel equipped with a stirrer, temperature adjuster, reflux condenser and pressure reducing device. After pressure reduction to 30 Torr, the suspension was heated to 35° C. Then, after further adjusting the vacuum level to 140 Torr, the suspension was heated to 57° C. to cause aggregation of primary particles to form secondary particles with a volume average particle diameter of 10 μm. Particle diameters were measured using a Coulter counter (product of Coulter Electrics). Then, the organic solvent in the secondary particles, namely the dispersed phase, was completely distilled off out of the system to solidify the dispersed phase.

In Table 5, “YF3919” is Toshiba Silicone's polysiloxane type surface modifier. The ultraviolet absorber is Tinuvin 928 (trademark; product of Ciba Specialty Chemicals Inc.), and the antioxidant is Tinuvin 144 (trademark; product of Ciba Specialty Chemicals Inc.). The “curing agent dispersion” is the one prepared as described above in “Preparation of a curing agent dispersion”.

TABLE 5

| | | Suspension- | |
|---|---|---|---|
| Method of production | | derived | Ground |
| Coating | Resin F1 solution | 24 | — |
| composition | (solids 65%) | | |
| formulation | Resin G1 solution | 96 | — |
| (parts by | (solids 65%) | | |
| weight) | Solid resin F1 | — | 15.6 |
| | Solid resin G1 | — | 62.4 |
| | Curing agent dispersion | 75 | — |
| | Solid curing agent C1 | — | 22 |
| | YF3919 | 0.1 | 0.1 |
| | Benzoin | 0.3 | 0.3 |
| | Ultraviolet absorber | 1.2 | 1.2 |
| | Antioxidant | 1 | 1 |

### PRODUCTION EXAMPLE 5

Preparation of a Powder Clear Coating Composition 2 (Ground Powder Coating Composition)

A thermosetting powder coating composition was produced by the conventional dry process. Specifically, the organic solvent in the resin F1 and resin G1 was distilled off, and the thus-obtained solid resins were used as raw materials. Thus, these solid resins were mixed up together with other ingredients specified in Table 5 according to the formulation given therein using a Henschel mixer and further melt-kneaded at a temperature set at 95° C. using a melt kneader Buss Cokneader. The melt-kneaded substance was then cooled to room temperature and roughly ground again using a Henschel mixer and then ground using a hammer mill and further finely divided using a jet mill.

The powder obtained was classified using sieves to give a thermosetting powder coating composition with a weight average particle diameter of 10 μm. The “solid curing agent C1” in the ground powder coating composition was prepared by mixing 75 parts of 1,10-decanedicarboxylic acid with 25 parts of sebacic acid, followed by grinding to a volume average particle diameter of 3 μm.

### EXAMPLE 1

Commercial cold-rolled steel panels (SPCC-SD; products of Nippon Testpanel Co., Ltd.; 70 mm×150 mm×0.8 mm) were coated, by electrodeposition, with “Powernix 110” (cationic electrocoating composition; product of Nippon Paint Co., Ltd.) to give a dry film thickness of 20 μm and, after washing with water, the coats were baked by 20 minutes of heating at 170° C. Then, the water-borne white intermediate coating composition was applied thereto by two-stage air spraying application to give a dry film thickness of 35 μm, followed by 3 minutes of preheating at 80° C.

The test panels obtained were coated, in two stages, with Aquarex AR-2000 Silver (AR2000#1C0; trademark; metallic water-borne base coating composition, product of Nippon Paint Co., Ltd.) to give a dry film thickness of 15 μm under conditions of room temperature (25° C.) and 75% relative humidity using Metallic Bell COPES-IV type coater (ABB Industries' rotary spray type electrostatic coater for water-borne coating compositions). During the interval between the two applications, interval setting was carried out for 1.5 minutes. After an interval of 5 minutes following the second application, setting was carried out. Then, preheating was carried out at 80° C. for 3 minutes.

Then, the primer was applied to the test panels to give a dry film thickness of 10 μm using the Metallic Bell COPES-IV type coater. Preheating was carried out at 80° C. for 3 minutes, followed by 25 minutes of heating at 145° C. for baking.

To the thus-obtained test panels was applied the powder clear coating composition 1 in the manner of electrostatic coating so as to give a dry film thickness gradient comprising 50, 60, 70, . . . , and 150 μm, followed by 25 minutes of heating at 145° C. for baking.

### EXAMPLES 2 to 16 and COMPARATIVE EXAMPLES 1 to 8

Test panels were coated with the coating compositions shown in Tables 6 to 9 under the preheating conditions and baking conditions shown therein.

The test panels obtained in Examples 1 to 16 and Comparative Examples 1 to 8 were evaluated with respect to the following items. The results are shown in Tables 6 to 9.

Yellowing

For evaluating the extent of discoloration (yellowing) of the coating films in the step of curing, b values were measured using a color difference meter (product name: “SM-T45”; product of Suga Test Instruments Co., Ltd.). The b value is an index of yellowing of the films and, in Tables 6 to 9, each Δb value is the difference between the b value at the end of step of application of or coating with the water-borne metallic base and the b value after curing of the powder clear coating composition. A smaller Δb value indicates a slighter extent of clear coating film discoloration (yellowing) upon baking, and values not higher than 0.5 are regarded as satisfactory. Those test panels having a clear coating film thickness of 50 μm were subjected to measurement.

Clear Popping (Pinhole Formation) Limit Thickness

Clear Film Thickness Critical for Popping

The test panels having coating films showing a dry film thickness gradient comprising 50, 60, 70, . . . , and 150 μm were observed by the eye, and the upper limit to the clear coating film thickness at which no popping (no pinhole formation) occurred. That the numerical value obtained is greater indicates that the tendency toward popping is weaker.

Gloss

The coating films obtained were evaluated for luster by measuring G values using “Wavescan T” (product name; product of BYK-Gardner GmbH). The lower the value is, the better the luster is. Values not exceeding 9 are regarded as satisfactory. Those test panels having a clear coating film thickness of 50 μm were subjected to measurement.

Adhesion

The multilayer coating films obtained were given 2-mm-square cuts reaching the substrate in checkerboard pattern and immersed in water at 60° C. for 72 hours, a Nichiban sticky tape was applied to the cut area of each film and then peeled off, and the number of squares adhering to the tape was counted. Those test panels having a clear coating film thickness of 50 μm were subjected to testing.
◯: 0/100
Δ: Less than 10/100;
×: 10/100 or more.

TABLE 6

| | | | | | | Comparative | Comparative |
|---|---|---|---|---|---|---|---|
| | | Example 1 | Example 2 | Example 3 | Example 4 | Example 1 | Example 2 |
| Intermediate | Coating | (Water-borne | (Water-borne | (Water-borne | (Water-borne | (Water-borne | (Water-borne |
| | composition | white | white | white | white | white | white |
| | | intermediate) | intermediate) | intermediate) | intermediate) | intermediate) | intermediate) |
| | Preheating | 80° C. × 3 min | 80° C. × 3 min | 80° C. × 3 min | 80° C. × 3 min | 80° C. × 3 min | 80° C. × 3 min |
| | conditions | | | | | | |
| | NV after | 78 | 78 | 78 | 78 | 78 | 78 |
| | preheating | | | | | | |
| Base | Base coating | AR2000 # 1C0 | AR2000 # 1C0 | AR2000 # 1C0 | AR2000 # 1C0 | AR2000 # 1C0 | AR2000 # 1C0 |
| | composition | | | | | | |
| | Preheating | 80° C. × 3 min | 80° C. × 3 min | 80° C. × 3 min | 80° C. × 3 min | 80° C. × 3 min | 80° C. × 3 min |
| | conditions | | | | | | |
| | NV after | 82 | 82 | 82 | 82 | 82 | 82 |
| | preheating | | | | | | |
| | Baking conditions | None | 145° C. × 25 min | None | 145° C. × 25 min | None | 145° C. × 25 min |
| Primer | Primer | Water-borne | Water-borne | Solvent-borne | Solvent-borne | None | None |
| | Preheating | 80° C. × 3 min | 80° C. × 3 min | 80° C. × 3 min | 80° C. × 3 min | — | — |
| | conditions | | | | | | |
| | Baking conditions | 145° C. × 25 min | None | 145° C. × 25 min | None | — | — |
| Clear | Clear coating | Powder clear 1 | Powder clear 1 | Powder clear 1 | Powder clear 1 | Powder clear 1 | Powder clear 1 |
| | composition | (suspension- | (suspension- | (suspension- | (suspension- | (suspension- | (suspension- |
| | | derived) | derived) | derived) | derived) | derived) | derived) |
| | Baking conditions | 145° C. × 25 min | 145° C. × 25 min | 145° C. × 25 min | 145° C. × 25 min | 145° C. × 25 min | 145° C. × 25 min |
| Evaluation | Yellowing | 0.11 | 0.13 | 0.19 | 0.24 | 0.7 | 0.39 |
| results | (Δb value) | | | | | | |
| | Clear popping | 130 | 130 | 130 | 120 | 70 | 130 |
| | limit thickness | | | | | | |
| | (μm) | | | | | | |
| | G value | 6 | 7 | 7 | 7 | 10 | 12 |
| | Adhesion | ∘ | ∘ | ∘ | ∘ | Δ | x |
| | (cross cut test) | | | | | | |

TABLE 7

| | | | | | | Comparative | Comparative |
|---|---|---|---|---|---|---|---|
| | | Example 5 | Example 6 | Example 7 | Example 8 | Example 3 | Example 4 |
| Intermediate | Coating | (Water-borne | (Water-borne | (Water-borne | (Water-borne | (Water-borne | (Water-borne |
| | composition | white | white | white | white | white | white |
| | | intermediate) | intermediate) | intermediate) | intermediate) | intermediate) | intermediate) |
| | Preheating | 80° C. × 3 min | 80° C. × 3 min | 80° C. × 3 min | 80° C. × 3 min | 80° C. × 3 min | 80° C. × 3 min |
| | conditions | | | | | | |
| | NV after | 78 | 78 | 78 | 78 | 78 | 78 |
| | preheating | | | | | | |
| Base | Base coating | AR2000 # 1C0 | AR2000 # 1C0 | AR2000 # 1C0 | AR2000 # 1C0 | AR2000 # 1C0 | AR2000 # 1C0 |
| | composition | | | | | | |
| | Preheating | 80° C. × 3 min | 80° C. × 3 min | 80° C. × 3 min | 80° C. × 3 min | 80° C. × 3 min | 80° C. × 3 min |
| | conditions | | | | | | |
| | NV after | 82 | 82 | 82 | 82 | 82 | 82 |
| | preheating | | | | | | |
| | Baking conditions | None | 145° C. × 25 min | None | 145° C. × 25 min | None | 145° C. × 25 min |
| Primer | Primer | Water-borne | Water-borne | Solvent-borne | Solvent-borne | None | None |
| | Preheating | 80° C. × 3 min | 80° C. × 3 min | 80° C. × 3 min | 80° C. × 3 min | — | — |
| | conditions | | | | | | |
| | Baking conditions | 145° C. × 25 min | None | 145° C. × 25 min | None | — | — |
| Clear | Clear coating | Powder clear 2 | Powder clear 2 | Powder clear 2 | Powder clear 2 | Powder clear 2 | Powder clear 2 |
| | composition | (ground) | (ground) | (ground) | (ground) | (ground) | (ground) |
| | Baking conditions | 145° C. × 25 min | 145° C. × 25 min | 145° C. × 25 min | 145° C. × 25 min | 145° C. × 25 min | 145° C. × 25 min |
| Evaluation | Yellowing | 0.12 | 0.2 | 0.19 | 0.27 | 0.81 | 0.46 |
| results | (Δb value) | | | | | | |
| | Clear popping | 120 | 120 | 120 | 120 | 70 | 120 |
| | limit thickness | | | | | | |
| | (μm) | | | | | | |
| | G value | 8 | 9 | 8 | 9 | 12 | 14 |
| | Adhesion | ∘ | ∘ | ∘ | ∘ | Δ | x |
| | (cross cut test) | | | | | | |

TABLE 8

| | | | | | | Comparative | Comparative |
|---|---|---|---|---|---|---|---|
| | | Example 9 | Example 10 | Example 11 | Example 12 | Example 5 | Example 6 |
| Intermediate | Coating | (Water-borne | (Water-borne | (Water-borne | (Water-borne | (Water-borne | (Water-borne |
| | composition | white | white | white | white | white | white |
| | | intermediate) | intermediate) | intermediate) | intermediate) | intermediate) | intermediate) |
| | Preheating | 80° C. × 3 min | 80° C. × 3 min | 80° C. × 3 min | 80° C. × 3 min | 80° C. × 3 min | 80° C. × 3 min |
| | conditions | | | | | | |
| | NV after | 78 | 78 | 78 | 78 | 78 | 78 |
| | preheating | | | | | | |
| | Baking conditions | 145° C. × 25 min | 145° C. × 25 min | 145° C. × 25 min | 145° C. × 25 min | 145° C. × 25 min | 145° C. × 25 min |
| Base | Base coating | AR2000 # 1C0 | AR2000 # 1C0 | AR2000 # 1C0 | AR2000 # 1C0 | AR2000 # 1C0 | AR2000 # 1C0 |
| | composition | | | | | | |
| | Preheating | 80° C. × 3 min | 80° C. × 3 min | 80° C. × 3 min | 80° C. × 3 min | 80° C. × 3 min | 80° C. × 3 min |
| | conditions | | | | | | |
| | NV after | 82 | 82 | 82 | 82 | 82 | 82 |
| | preheating | | | | | | |
| | Baking conditions | None | 145° C. × 25 min | None | 145° C. × 25 min | None | 145° C. × 25 min |
| Primer | Primer | Water-borne | Water-borne | Solvent-borne | Solvent-borne | None | None |
| | Preheating | 80° C. × 3 min | 80° C. × 3 min | 80° C. × 3 min | 80° C. × 3 min | — | — |
| | conditions | | | | | | |
| | Baking conditions | 145° C. × 25 min | None | 145° C. × 25 min | None | — | — |
| Clear | Clear coating | Powder clear 1 | Powder clear 1 | Powder clear 1 | Powder clear 1 | Powder clear 1 | Powder clear 1 |
| | composition | (suspension- | (suspension- | (suspension- | (suspension- | (suspension- | (suspension- |
| | | derived) | derived) | derived) | derived) | derived) | derived) |
| | Baking conditions | 145° C. × 25 min | 145° C. × 25 min | 145° C. × 25 min | 145° C. × 25 min | 145° C. × 25 min | 145° C. × 25 min |
| Evaluation | Yellowing | 0.11 | 0.11 | 0.15 | 0.19 | 0.55 | 0.21 |
| results | (Δb value) | | | | | | |
| | Clear popping | 130 | 130 | 130 | 130 | 100 | 130 |
| | limit thickness | | | | | | |
| | (μm) | | | | | | |
| | G value | 6 | 6 | 6 | 6 | 9 | 10 |
| | Adhesion | ∘ | ∘ | ∘ | ∘ | ∘ | x |
| | (cross cut test) | | | | | | |

TABLE 9

| | | | | | | Comparative | Comparative |
|---|---|---|---|---|---|---|---|
| | | Example 13 | Example 14 | Example 15 | Example 16 | Example 7 | Example 8 |
| Intermediate | Coating | (Water-borne | (Water-borne | (Water-borne | (Water-borne | (Water-borne | (Water-borne |
| | composition | white | white | white | white | white | white |
| | | intermediate) | intermediate) | intermediate) | intermediate) | intermediate) | intermediate) |
| | Preheating | 80° C. × 3 min | 80° C. × 3 min | 80° C. × 3 min | 80° C. × 3 min | 80° C. × 3 min | 80° C. × 3 min |
| | conditions | | | | | | |
| | NV after | 78 | 78 | 78 | 78 | 78 | 78 |
| | preheating | | | | | | |
| | Baking conditions | 145° C. × 25 min | 145° C. × 25 min | 145° C. × 25 min | 145° C. × 25 min | 145° C. × 25 min | 145° C. × 25 min |
| Base | Base coating | AR2000 # 1C0 | AR2000 # 1C0 | AR2000 # 1C0 | AR2000 # 1C0 | AR2000 # 1C0 | AR2000 # 1C0 |
| | composition | | | | | | |
| | Preheating | 80° C. × 3 min | 80° C. × 3 min | 80° C. × 3 min | 80° C. × 3 min | 80° C. × 3 min | 80° C. × 3 min |
| | conditions | | | | | | |
| | NV after | 82 | 82 | 82 | 82 | 82 | 82 |
| | preheating | | | | | | |
| | Baking conditions | None | 145° C. × 25 min | None | 145° C. × 25 min | None | 145° C. × 25 min |
| Primer | Primer | Water-borne | Water-borne | Solvent-borne | Solvent-borne | None | None |
| | Preheating | 80° C. × 3 min | 80° C. × 3 min | 80° C. × 3 min | 80° C. × 3 min | — | — |
| | conditions | | | | | | |
| | Baking conditions | 145° C. × 25 min | None | 145° C. × 25 min | None | — | — |
| Clear | Clear coating | Powder clear 2 | Powder clear 2 | Powder clear 2 | Powder clear 2 | Powder clear 2 | Powder clear 2 |
| | composition | (ground) | (ground) | (ground) | (ground) | (ground) | (ground) |
| | Baking conditions | 145° C. × 25 min | 145° C. × 25 min | 145° C. × 25 min | 145° C. × 25 min | 145° C. × 25 min | 145° C. × 25 min |
| Evaluation | Yellowing | 0.13 | 0.15 | 0.19 | 0.23 | 0.67 | 0.38 |
| results | (Δb value) | | | | | | |
| | Clear popping | 130 | 130 | 130 | 130 | 90 | 130 |
| | limit thickness | | | | | | |
| | (μm) | | | | | | |
| | G value | 7 | 9 | 8 | 8 | 12 | 12 |
| | Adhesion | ∘ | ∘ | ∘ | ∘ | ∘ | x |
| | (cross cut test) | | | | | | |

It was revealed that the multilayer coating films obtained in the Examples were resistant to yellowing with time, excellent in popping preventing effect and good in appearance. In particular, it was revealed that whereas the powder clear coating films of the multilayer coating films as obtained in the Comparative Examples without primer application were unsatisfactory in adhesion, the powder clear coating films obtained in the Examples were good in adhesion.

### INDUSTRIAL APPLICABILITY

The method of forming multilayer coating films according to the invention uses a powder clear coating composition to thereby reduce the VOC content and therefore is environment-friendly and, in addition, can form clear coating films showing good adhesion even on cured base coating films by applying a primer and thus is a method capable of providing multilayer coating films resistant to such unfavorable changes in appearance as yellowing.

1. A method of forming multilayer coating films on substrates having a cationically electrodeposited coating film using a water-borne intermediate coating composition, a water-borne base coating composition and a powder clear-coating composition,
wherein said method comprises:
a step (I) of applying the water-borne intermediate coating composition,
a step (B) of applying the water-borne base coating composition onto the intermediate coating film formed in the step (I),
a step (P) of applying a primer onto the base coating film formed in the step (B) and
a step (C) of applying the powder clear coating composition onto the primer coating film formed in the step (P), and
a step (H) of curing by heating is carried out just after the step (B) and/or just after the step (P).

2. The method of forming multilayer coating films according to claim 1,
wherein the primer is a solvent-borne one and comprises an alkoxysilyl group- and epoxy group-containing resin (A).

3. The method of forming multilayer coating films according to claim 1,
wherein the primer is a water-borne one.

4. The method of forming multilayer coating films according to claim 1,
wherein the powder clear coating composition is a suspension-derived powder coating composition.

5. The method of forming multilayer coating films according to claim 1,
wherein the substrate is an automotive body or automotive part.

6. A multilayer coating film which is obtained by the method of forming multilayer coating films according to claim 1.

7. The method of forming multilayer coating films according to claim 2,
wherein the powder clear coating composition is a suspension-derived powder coating composition.

8. The method of forming multilayer coating films according to claim 3,
wherein the powder clear coating composition is a suspension-derived powder coating composition.

9. The method of forming multilayer coating films according to claim 2,
wherein the substrate is an automotive body or automotive part.

10. The method of forming multilayer coating films according to claim 3,
wherein the substrate is an automotive body or automotive part.

11. The method of forming multilayer coating films according to claim 4,
wherein the substrate is an automotive body or automotive part.

12. A multilayer coating film which is obtained by the method of forming multilayer coating films according to claim 2.

13. A multilayer coating film which is obtained by the method of forming multilayer coating films according to claim 3.

14. A multilayer coating film which is obtained by the method of forming multilayer coating films according to claim 4.

15. A multilayer coating film which is obtained by the method of forming multilayer coating films according to claim 5.

16. The method of forming multilayer coating films according to claim 7, wherein the substrate is an automotive body or automotive part.

17. The method of forming multilayer coating films according to claim 8, wherein the substrate is an automotive body or automotive part.

18. A multilayer coating film which is obtained by the method of forming multilayer coating films according to claim 7.

19. A multilayer coating mm which is obtained by the method of forming multilayer coating films according to claim 8.

20. A multilayer coating film which is obtained by the method of forming multilayer coating films according to claim 9.
